(19) United States
(12) Patent Application Publication
(10) Pub. No.: US 2014/0191642 A1
(43) Pub. Date: Jul. 10, 2014

(54) CABINET OF AUTOMATIC VENDING MACHINE

(71) Applicants: HON HAI PRECISION INDUSTRY CO., LTD., New Taipei (TW); HONG FU JIN PRECISION INDUSTRY (WUHAN) CO., LTD., Wuhan (CN)

(72) Inventors: SHUAI WU, Wuhan (CN); DE-XIA YIN, Wuhan (CN); WEI LIANG, Wuhan (CN); YU-LIN LIU, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/055,034

(22) Filed: Oct. 16, 2013

(30) Foreign Application Priority Data
Jan. 7, 2013 (CN) 2013100044221

(51) Int. Cl. G07F 9/10

(52) U.S. Cl. CPC G07F 9/10
USPC 312/326

(57) ABSTRACT

A cabinet includes a cabinet body, a front door, and a drive assembly. The front door is secured to the cabinet body and includes a door body, a supporting rod, and a sliding member. The supporting rod is located on the door body, and the sliding member surrounds on the supporting rod. The drive assembly is attached to the cabinet body and connected to the sliding member. The door body is rotatable relative to the cabinet body between an open position and a closed position. The sliding member is slidable in a first direction along the supporting rod to push the door body from the closed position to the open position, and in a second direction opposite to the first direction to pull the door body from the open position to the closed position driven by the drive assembly. The door body is thereby open or closed automatically.

### BACKGROUND

1. Technical Field

The present disclosure relates to cabinets, and more particularly to a cabinet of an automatic vending machine.

2. Description of Related Art

An automatic vending machine includes a cabinet body for storing items for sale and a front door for covering the cabinet body. Usually, the front door is very heavy with a plurality of functional units, such as thermal insulation unit, and it may be difficult to manually open or close the front door when repairing or adding items to the vending machine. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a cutaway, exploded, isometric of an embodiment of a cabinet.

FIG. 2 is an enlarged view of a circled portion II of FIG. 1.

FIG. 3 is an exploded, isometric of an installation member and a drive assembly of FIG. 1.

FIG. 4 is an isometric view of the installation member and the drive assembly of FIG. 3.

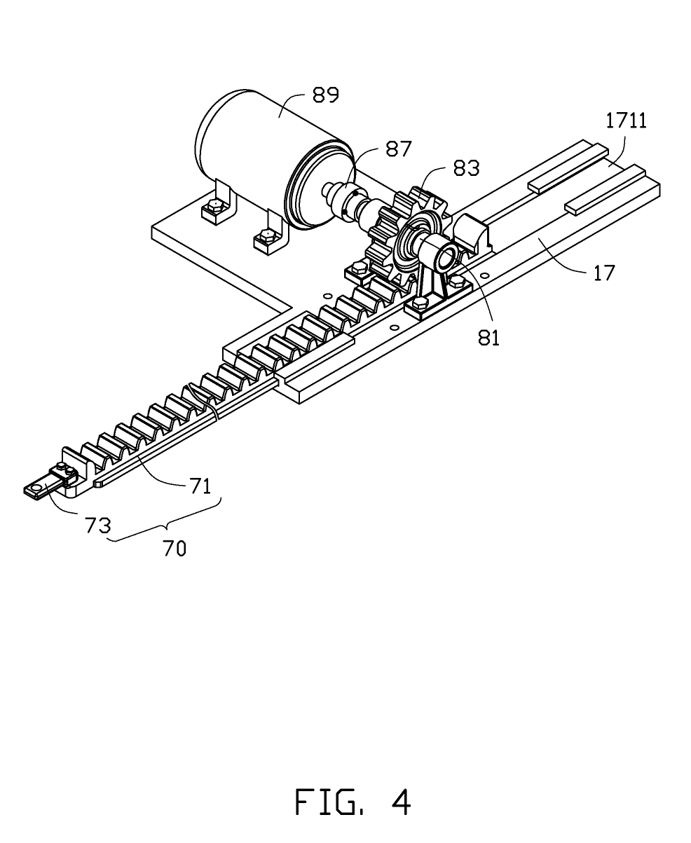

FIG. 5 is an isometric view of the cabinet of FIG. 1.

FIG. 6 is a cross-sectional view of the cabinet of FIG. 5 taken along line VI-VI, and the front door is in an open position.

FIG. 7 is similar to FIG. 6 but view from another aspect.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.

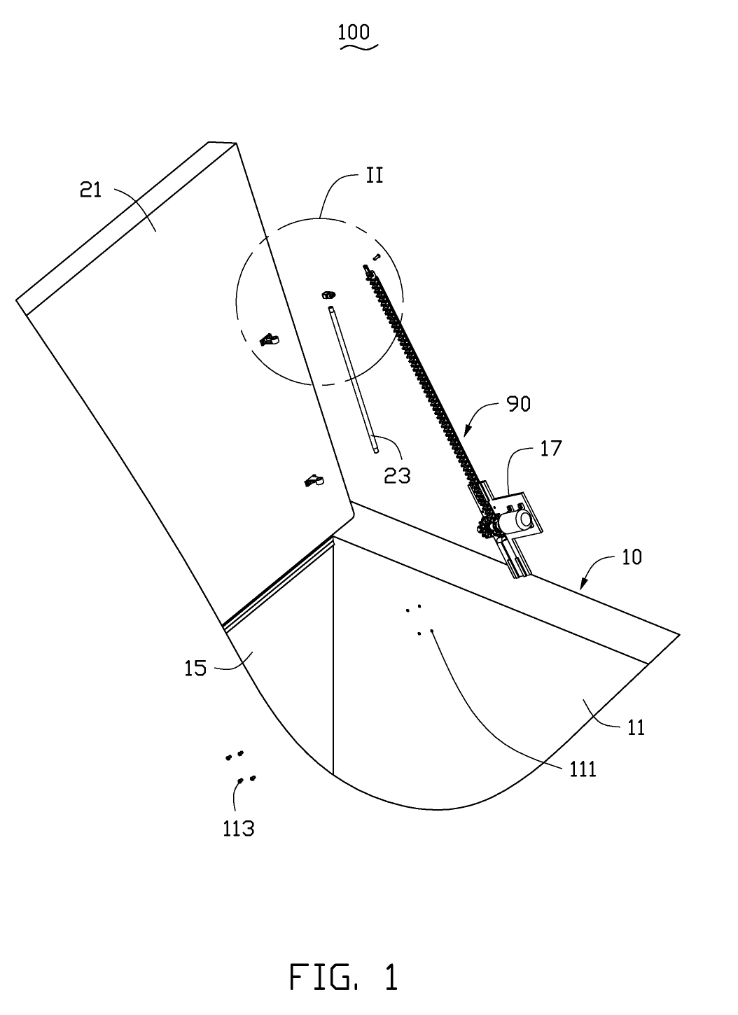

FIGS. 1-3 illustrate an embodiment of a cabinet 100 of automatic vending machine which includes a cabinet body 10, a front door 20, and a drive assembly 90.

The cabinet body 10 includes a top plate 11, a bottom plate 13, and two side plates 15. The two side plates 15 are connected to the top plate 11 and the bottom plate 13. In one embodiment, the top plate 11 is substantially parallel to the bottom plate 13, the two side plates 15 are parallel to each other and perpendicular to the top plate 11 and the bottom plate 13. The top plate 11 defines four installation holes 111. Four supporting legs 131 are located on the bottom plate 13, for supporting the cabinet 100.

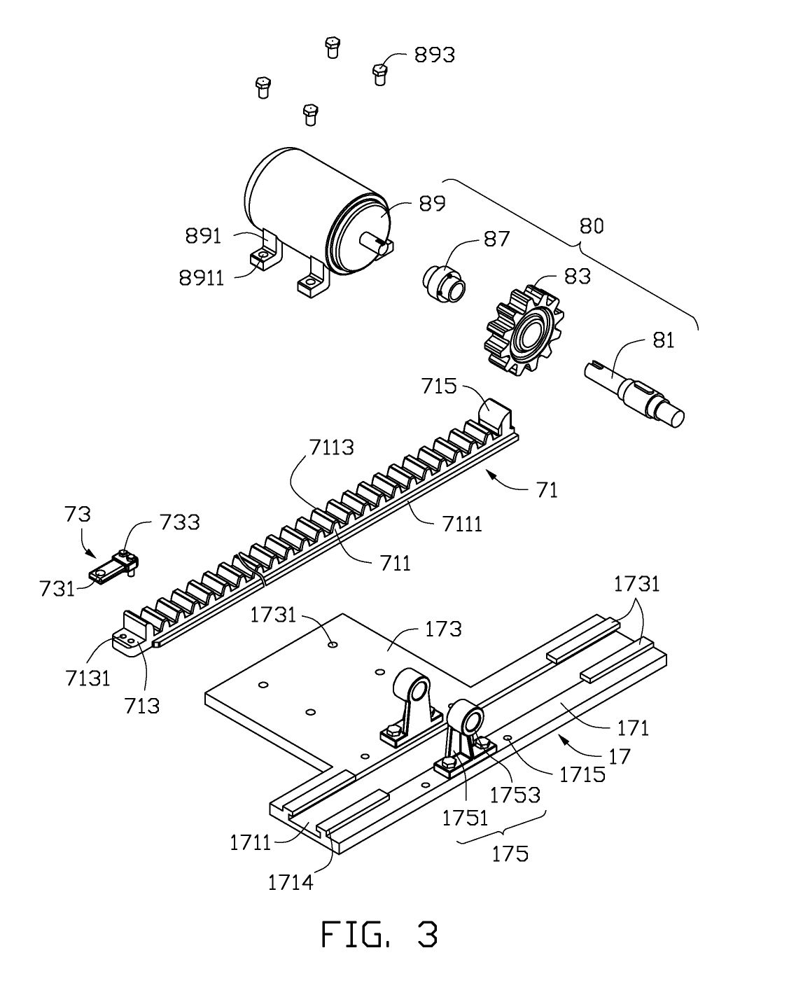

FIG. 3 shows that, an installation member 17 is installed on the cabinet body 11 and includes a positioning board 171, a securing board 173, and two installation brackets 175. The positioning board 171 is substantially elongated and defines a sliding slot 1711 for receiving the drive assembly 90. Two first resisting pieces 1713 and two second resisting pieces 1714 are located on the positioning board 171, for resisting the drive assembly 90. The two first resisting pieces 1713 are adjacent to a first end of the positioning board 171 and extend towards each other from opposite edges of the sliding slot 1711. The two second resisting pieces 1714 are adjacent to a second end of the positioning board 171 and extend towards each other from the opposite edges of the sliding slot 1711. The positioning board 171 defines four positioning holes 1715 corresponding to the four installation holes 111.

The two installation brackets 175 are secured to the supporting board 171 and arranged at opposite sides of the sliding slot 1711. Each of installation brackets 175 includes an installation base 1751 and an installation sleeve 1753 located on the installation base 1751. The installation base 1751 is secured to the supporting board 171 by well known ways, such as screws, to secure corresponding installation bracket 175 to the supporting board 171. The securing board 173 extends from one side of the positioning board 171 and defines four securing holes 1731.

The front door 20 includes a door body 21, a supporting rod 23, and a sliding member 25. Two supporting brackets 211 are located on an inside of the door body 21, for supporting the supporting rod 23. Each of the two supporting brackets 211 includes a supporting base 2111 and a supporting sleeve 2113 located on the supporting base 2111. The supporting rod 23 is substantially a column, and two opposite ends of the supporting rod 23 can be inserted into the supporting sleeves 2113 of the two supporting brackets 211.

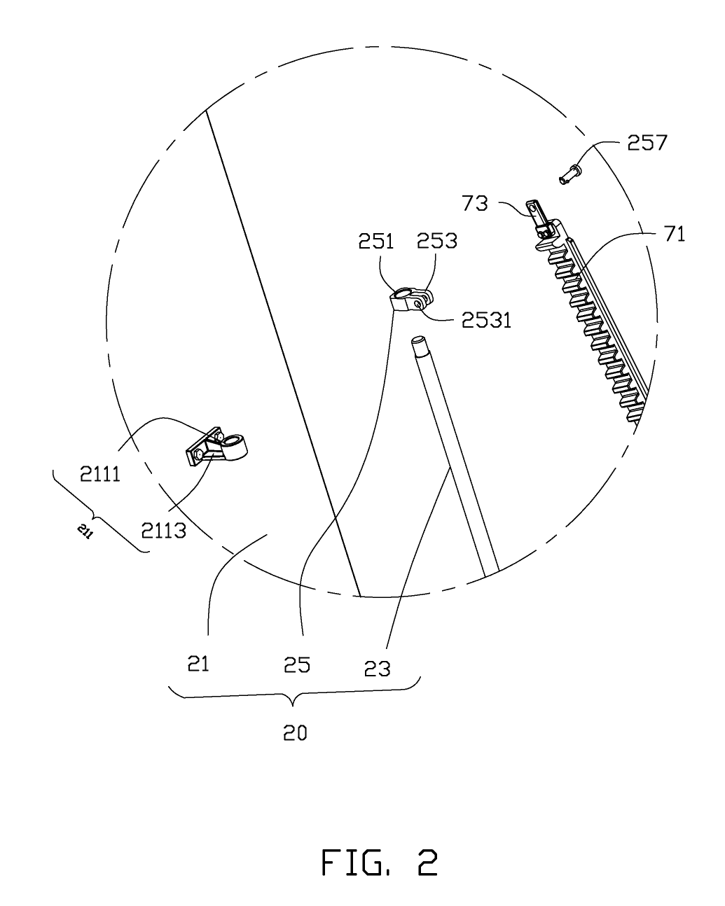

FIG. 2 shows that, the sliding member 25 slidably surrounds on the supporting rod 23 and includes a sliding sleeve 251 and two limiting tabs 253 located on the sliding sleeve 251. The two limiting tabs 253 are parallel to each other, and each of the two limiting tabs 253 defines a limiting hole 2531.

FIG. 3 shows that, the drive assembly 90 includes a slave member 70, and a drive mechanism 80. The slave member 70 includes an elongated slave strip 71 and a connecting piece 73. The slave strip 71 includes a strip body 711, a connecting tab 713, and a blocking tab 715. Two flanges 7111 extends from the strip body 711, and the strip body 711 has a plurality of teeth 7113. The connecting tab 713 extends outwards from a first end of the strip body 711, and the blocking tab 715 extends upwards from a second end of the strip body 711. The connecting tab 713 defines two connecting holes 7131 corresponding to the connecting piece 73. The connecting piece 73 defines a through hole 731 corresponding to the limiting holes 2531 of the sliding member 25. Two bolts 733 are located on the connecting piece 73 and can be locked into the two connecting holes 7131 to secure the connecting piece 73 to the slave strip 71.

The drive mechanism 80 includes a pivot shaft 81, a drive gear 83, a connection shaft 87, and a motor 89. Two opposite ends of the pivot shaft 81 are rotatably engaged in the installation sleeves 1753 of the two installation brackets 175, and one end of the pivot shaft 81 is connected to the connection shaft 83. The drive gear 83 surrounds on the pivot shaft 81 and is rotatable with the pivot shaft 81. The connection shaft 87 is connected to the motor 85 with the pivot shaft 81 and can rotate the pivot shaft 81 when the motor 89 drives the connection shaft 87. Four installation legs 891 are located on the motor 89, and each of the four installation legs 891 defines a mounting hole 8911 corresponding to each of the four securing holes 1731.

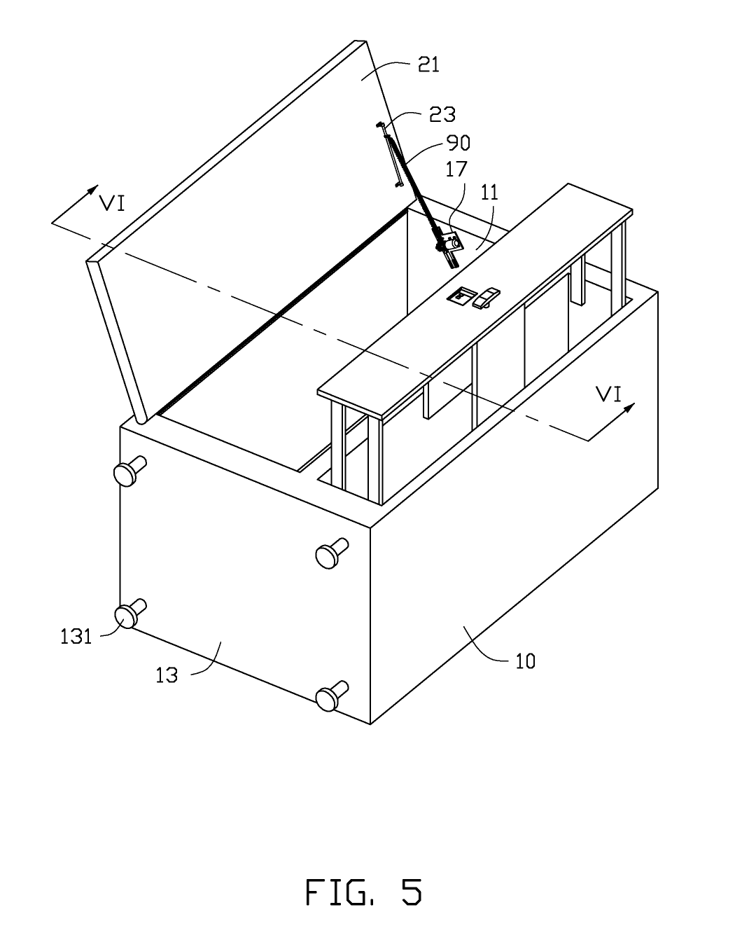

FIG. 5 shows that in assembly, the sliding member 25 surrounds on the supporting rods 23. The supporting rod 23 is engaged in the supporting sleeves 2113 of the two supporting brackets 211.

The slave strip 71 of the slave member 70 is received in the sliding slot 1711 of the installation member 17. The drive gear 83 surrounds on the pivot shaft 81, and the pivot shaft 81 is rotatably engaged into the installation sleeves 1753 of the two installation brackets 175. The connecting shaft 87 is installed on the motor 89 and connected to one end of the pivot shaft 81. The motor 87 is secured to the securing board 173 by four securing members 893 and locked into the mounting holes 8911 of the motor 89 and the securing holes 1731. Thus, the drive gear 83 is meshed with the plurality of teeth 7113 of the slave strip 71.

The installation member 17 abuts on the top plate 11, each of the four positioning holes 1715 is aligned with each of the four securing holes 111. Four locking members 113 are locked into the four positioning holes 1715 and the four securing holes 111, to secure the installation member 17 to the cabinet body 10. The connecting piece 73 is engaged between the two limiting tabs 253, and an engaging member 257 is locked into the limiting holes 2531 and the connecting hole 731 to connect the sliding member 25 with the slave strip 71.

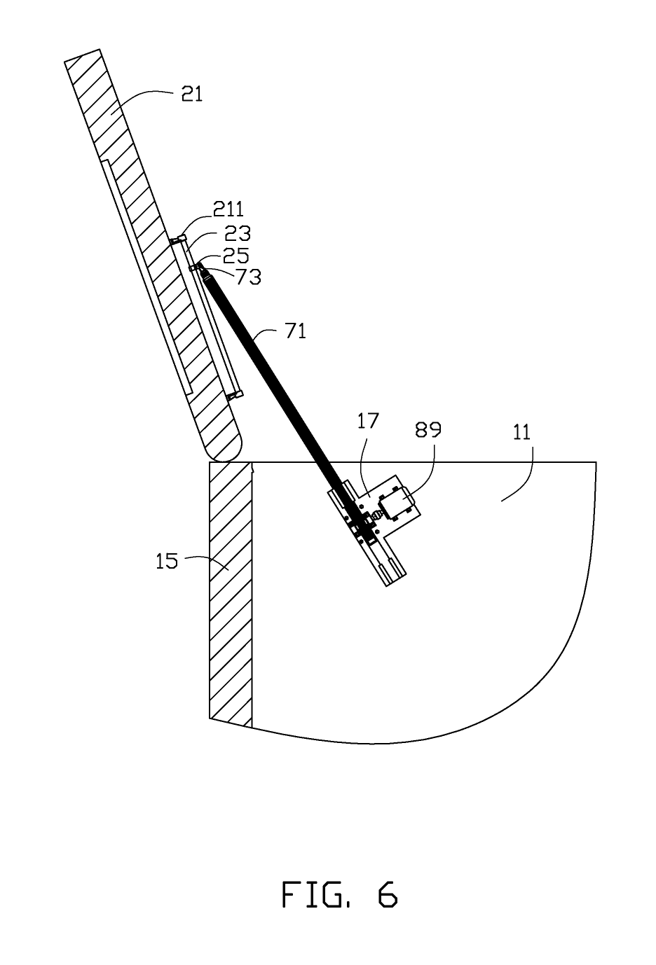

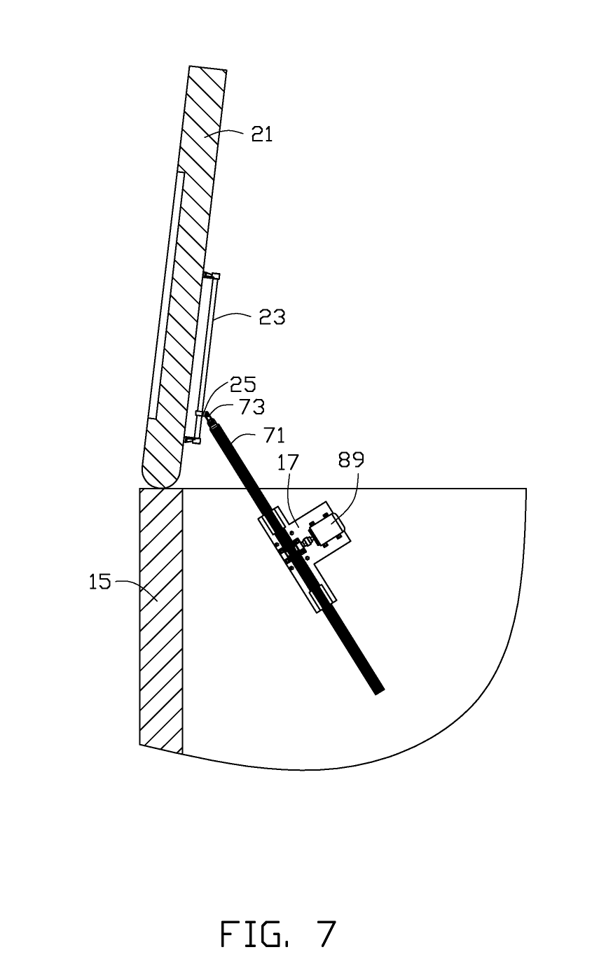

FIGS. 6-7 show that, in use, the front body 21 is rotatable relative to the cabinet body 10 between an open position where the front body 21 uncovers the cabinet body 10, and a closed position where the front body 21 covers the cabinet body 10. When the front body 21 needs to be open, the motor 89 works to rotate the pivot shaft 81 clockwise. The drive gear 83 is rotated with the pivot shaft 81 clockwise, and the slave member 70 is slid in a third direction driven by the drive gear 83. The slave member 70 pushes the sliding member 25 to slide in a first direction, and the front door 20 is rotated to be in the open position. In this embodiment, an acute angle is defined between the first direction and the third direction.

When the front body 21 is needs to be closed, the motor 89 works to rotate the pivot shaft 81 anticlockwise. The drive gear 83 is rotated with the pivot shaft 81 anticlockwise, and the slave member 70 is slid in a fourth direction driven by the drive gear 83. Simultaneously, the slave member 70 pulls the sliding member to slide in a second direction opposite to the first direction, and the front door 20 is rotated to the closed position. In this embodiment, an acute angle is defined between the second direction and the fourth direction.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A cabinet of an automatic vending machine comprising:
a cabinet body;
a front door secured to the cabinet body and comprising a door body, a supporting rod on the door body, and a sliding member surrounding the supporting rod; and
a drive assembly attached to the cabinet body and connected to the sliding member,
wherein the door body is rotatable relative to the cabinet body between an open position and a close position; the sliding member is slidable in a first direction along the supporting rod to push the door body from the close position to the open position, and the sliding member is slidable in a second direction opposite to the first direction and being driven by the drive assembly to pull the door body from the open position to the close position.

2. The cabinet of claim 1, wherein the drive assembly comprises a slave member, and the slave member is connected to the sliding member and configured to drive the sliding member to slide on the supporting rod.

3. The cabinet of claim 2, wherein an installation member is located on the cabinet body and comprises a supporting board with a sliding slot, the slave member comprises a sliding strip, and the sliding strip is slidably received in the sliding slot.

4. The cabinet of claim 3, wherein the slave member further comprises a connecting piece, and the connecting piece is connected to the slave strip by the sliding member.

5. The cabinet of claim 4, wherein the sliding member comprises two limiting tabs parallel to each other, and the connecting piece is engaged between the two limiting tab and rotatable relative to each of the two limiting tabs.

6. The cabinet of claim 5, wherein the sliding member further comprises a sliding sleeve surrounding the supporting rod, and each of the two limiting tabs is connected to the sliding sleeve.

7. The cabinet of claim 3, wherein two first resisting pieces and two second resisting pieces are located on the supporting board, two flanges extending from opposite sides of the slave strip, and each of the two first resisting pieces and each of the two second resisting pieces abut each of the two flanges.

8. The cabinet of claim 7, wherein the two first resisting pieces extend towards each other, and the two second resisting pieces extend towards each other.

9. The cabinet of claim 3, wherein the drive assembly further comprises a drive gear, the drive gear is meshed with a plurality of teeth of the slave strip, and the slave strip is slidable along a third direction and a fourth direction opposite to the third direction and being driven by the drive gear.

10. The cabinet of claim 9, wherein an acute angle is defined between the first direction and the third direction, and an acute angle is defined between the second direction and the fourth direction.

11. A cabinet of automatic vending machine comprising:
a cabinet body comprising a top plate;
a front door secured to the cabinet body and comprising a door body, a supporting rod on the door body, and a sliding member surrounding the supporting rod; and
a drive assembly attached to the top plate and connected to the sliding member,
wherein the sliding member is slidable in a first direction along the supporting rod to push the door body to an open position, and the sliding member is slidable in a second direction opposite to the first direction to pull the door body to a close position and being driven by the drive assembly.

12. The cabinet of claim 11, wherein the drive assembly comprises a slave member, the slave member is connected to the sliding member and configured to drive the sliding member to slide on the supporting rod.

13. The cabinet of claim 12, wherein an installation member is located on the cabinet body and comprises a supporting board with a sliding slot, the slave member comprises a sliding strip, and the sliding strip is slidably received in the sliding slot.

14. The cabinet of claim 13, wherein the slave member further comprises a connecting piece, and the connecting piece is connected to the slave strip by the sliding member.

15. The cabinet of claim 14, wherein the sliding member comprises two limiting tabs parallel to each other, the connecting piece is engaged between the two limiting tab and rotatable relative to each of the two limiting tabs.

16. The cabinet of claim 15, wherein the sliding member further comprises a sliding sleeve surrounding the supporting rod, and each of the two limiting tabs is connected to the sliding sleeve.

17. The cabinet of claim 13, wherein two first resisting pieces and two second resisting pieces are located on the supporting board, two flanges extend from opposite sides of the slave strip, and each of the two first resisting pieces and each of the two second resisting pieces abut each of the two flanges.

18. The cabinet of claim 17, wherein the two first resisting pieces extend towards each other, and the two second resisting pieces extend towards each other.

19. The cabinet of claim 13, wherein the drive assembly further comprises a drive gear, the drive gear is meshed with a plurality of teeth of the slave strip, and the slave strip is slidable along a third direction and a fourth direction opposite to the third direction and being driven by the drive gear.

20. The cabinet of claim 19, wherein an acute angle is defined between the first direction and the third direction, and an acute angle is defined between the second direction and the fourth direction.
